(19) United States
(12) Patent Application Publication
(10) Pub. No.: US 2012/0292079 A1
(43) Pub. Date: Nov. 22, 2012

(54) SIGNAL CABLE FOR ENDOSCOPE

(75) Inventors: Akira MURAMATSU, Tokyo (JP); Takahiko MITANI, Tokyo (JP)

(73) Assignee: OLYMPUS MEDICAL SYSTEMS CORP., Tokyo (JP)

(21) Appl. No.: 13/562,537

(22) Filed: Jul. 31, 2012

Related U.S. Application Data
(63) Continuation of application No. PCT/JP2011/079877, filed on Dec. 22, 2011.

(30) Foreign Application Priority Data
Jan. 31, 2011 (JP) 2011-018499

(51) Int. Cl. H01B 11/02

(52) U.S. Cl. 174/113 R

(57) ABSTRACT

A composite cable formed by unitizing coaxial wires of a drive signal system by twisting and bundling, and a composite cable formed by unitizing coaxial wires of an output signal system by twisting and bundling are arranged so as to be positioned substantially on a straight line passing through a cable center axis, and other electric wires of a power supply system are arranged at positions that are substantially symmetrical to each other with respect to the straight line passing through the cable center axis. Then, the composite cables and the simple wires are collectively twisted and bundled, a binding tape is wound on an outer circumference thereof, and an outer circumference of the binding tape is further shielded by an overall shield and covered by a sheath, which is an outer coating, thereby forming a signal cable.

### CROSS REFERENCE TO RELATED APPLICATION

This application is a continuation application of PCT/JP2011/079877 filed on Dec. 22, 2011 and claims benefit of Japanese Application No. 2011-018499 filed in Japan on Jan. 31, 2011, the entire contents of which are incorporated herein by this reference.

### BACKGROUND OF THE INVENTION

1. Field of the Invention

The present invention relates to a signal cable for an endoscope, the signal cable electrically connecting an image pickup section and a subsequent stage signal processing section of the endoscope.

2. Description of the Related Art

In recent years, industrial and medical endoscopes have been widely used. In particular, in the case of endoscopes including an image pickup section at a distal end of an elongated insertion portion thereof, for example, medical endoscopes enable an image of a site to be examined in a body cavity to be observed on a monitor, the image being picked up by inserting the insertion portion into the body cavity. An image pickup section disposed at a distal end of an insertion portion includes an image pickup device package formed by integrating a solid image pickup device such as a CCD or a CMOS and a circuit substrate. The image pickup section is supplied with, e.g., power supply signals and drive signals from a subsequent stage signal processing section via a signal cable and transmits output signals generated by picking up an image of an object to the subsequent stage signal processing section.

For such endoscopes, there is a demand for an increase of pixels in an image pickup device for image quality enhancement and/or noise suppression, and for example, as disclosed in Japanese Patent Application Laid-Open Publication No. 2008-307293, use of multicore signal cables is promoted. FIG. 12 illustrates a multicore signal cable similar to a signal cable disclosed in Japanese Patent Application Laid-Open Publication No. 2008-307293, and the signal cable 100 includes a signal cable with a single-layer structure in which an inclusion 101 such as a staple fiber yarn or a Kevlar fiber yarn is disposed at a center thereof, and around the inclusion 101, two coaxial wires 102, 102 of a drive signal system and two coaxial wires 103, 103 of an output signal system are arranged so as to face each other, and, three of six simple wires 104, . . . of a power supply system are arranged in each side between the drive signal system and the output signal system.

Meanwhile, however, for endoscopes, there is a demand for reduction in diameter of distal end portions for, e.g., reduction in distress of patients, and mere provision of a signal cable of a single layer results in provision of a signal cable with a large outer diameter, which is insufficient for responding to the demand for reduction in diameter of distal end portions of endoscopes.

Thus, recently, as illustrated in FIGS. 13 and 14, signal cables in which electric wire groups in a signal cable are arranged in two layers to enable reduction in outer diameter even if the signal cable has a multicore structure have been developed.

A signal cable 110, which is illustrated in FIG. 13, is a cable with a double-layer structure in which a composite cable 120 formed by twisting two coaxial wires 111, 111 of a drive signal system and one simple wire 112 for a ground together is arranged at a center thereof and around the composite cable 120, respective twos of four coaxial wires 113, . . . of an output signal system are arranged so as to substantially face each other, and between the twos, three and two of five simple wires 114, . . . of a power supply system are arranged on respective sides.

Also, a signal cable 130, which illustrated in FIG. 14, is a cable with a double-layer structure in which a composite cable 140 formed by twisting two coaxial wires 131, 131 of a drive signal system and inclusions 132, 132 together is arranged at a center thereof and around the composite cable 140, two coaxial wires 133, . . . of an output signal system are arranged so as to face each other, and between the coaxial wires 133, . . . , three of six simple wires 134 of a power supply system (including a ground) are arranged on each side.

### SUMMARY OF THE INVENTION

A signal cable for an endoscope according to an aspect of the present invention provides a signal cable for an endoscope, the signal cable electrically connecting an image pickup section and a subsequent stage signal processing section of the endoscope, wherein a plurality of composite cables each formed by unitizing a plurality of electric wires by twisting and bundling are provided; wherein in a cross-section perpendicular to a direction in which the signal cable extends, the plurality of composite cables are arranged in parallel along a straight line passing through a center axis of the entire signal cable and a plurality of non-unitized electric wires are arranged at positions that are substantially symmetrical to each other with respect to the straight line passing through the center axis; and wherein the plurality of unitized composite cables and the plurality of non-unitized electric wires are collectively twisted and bundled, thereby forming the signal cable.

Also, a signal cable for an endoscope according to another aspect of the present invention provides a signal cable for an endoscope, the signal cable electrically connecting an image pickup section and a subsequent stage signal processing section of the endoscope, wherein a plurality of composite cables each formed by unitizing a plurality of electric wires by twisting and bundling are provided; wherein a plurality of non-unitized electric wires are arranged at positions adjacent to the unitized composite cables; and wherein the plurality of unitized composite cables and the plurality of non-unitized electric wires are collectively twisted and bundled, thereby forming the signal cable.

### BRIEF DESCRIPTION OF THE DRAWINGS

FIG. 1 relates to a first embodiment of the present invention and is a diagram of an overall configuration of an endoscope apparatus;

FIG. 2 relates to the first embodiment of the present invention and is a cross-sectional view of a signal cable to be connected to an image pickup section;

FIG. 3 relates to the first embodiment of the present invention and is a cross-sectional view of a signal cable including composite cables each including a same number of coaxial wires;

FIG. 4 relates to the first embodiment of the present invention and is a cross-sectional view of a signal cable including composite cables that each includes simple wires;

FIG. 5 relates to the first embodiment of the present invention and is a cross-sectional view of a signal cable including conductor wires as inclusions;

FIG. 6 relates to the first embodiment of the present invention and is a cross-sectional view of a signal cable in which coaxial wires in a composite cable are dual-shielded;

FIG. 7 relates to the first embodiment of the present invention and is a cross-sectional view of a signal cable in which a shield of each coaxial wire in a composite cable has an increased outer diameter;

FIG. 8 relates to the first embodiment of the present invention and is a cross-sectional view of a signal cable in which a ground wire with a large gauge is arranged at a center thereof;

FIG. 9 relates to a second embodiment of the present invention and is a cross-sectional view of a signal cable including three composite cables;

FIG. 10 relates to the second embodiment of the present invention and is a cross-sectional view of a signal cable including four composite cables;

FIG. 11 relates to the second embodiment of the present invention and is a cross-sectional view of a signal cable including five composite cables;

FIG. 12 is a cross-sectional diagram illustrating an example of a signal cable with a conventional single-layer structure;

FIG. 13 is a cross-sectional diagram illustrating an example of a signal cable with a conventional double-layer structure; and

FIG. 14 is a cross-sectional diagram illustrating another example of a signal cable with a conventional double-layer structure.

### DETAILED DESCRIPTION OF THE PREFERRED EMBODIMENTS

Hereinafter, embodiments of the present invention will be described with reference to the drawings.

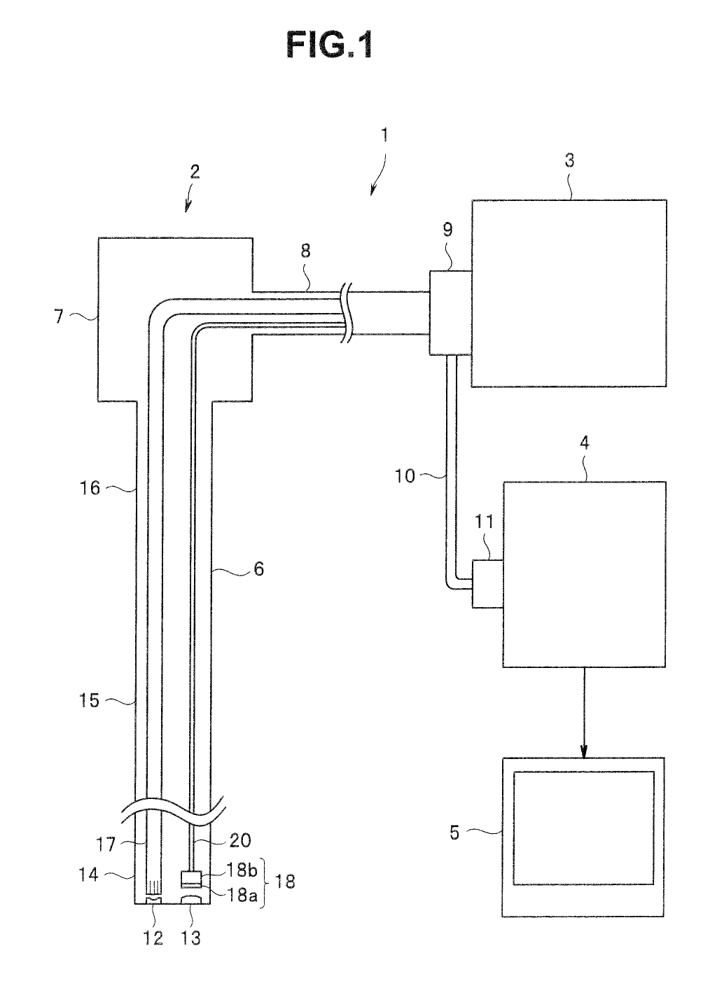

First, a first embodiment of the present invention will be described. In FIG. 1, reference numeral 1 denotes an endoscope apparatus, and in the present embodiment, the endoscope apparatus 1 includes an endoscope 2 including an image pickup device in a distal end portion thereof, a light source apparatus 3 that supplies illuminating light for observation to the endoscope 2, a processing apparatus 4 that performs various types of signal processing for the endoscope 2, and a monitor 5 that upon receipt of signals outputted from the processing apparatus 4, displays, e.g., an image of a site to be observed.

The endoscope 2 includes an elongated insertion portion 6 that is inserted into a site to be observed in, e.g., a body cavity, an operation section 7 provided so as to be continuous with a proximal end portion of the insertion portion 6, the operation section 7 doubling as a grasping portion, and a universal cord 8 provided so as to extend from a side face of the operation section 7. At an end portion of the universal cord 8, a connector 9 is provided, and the endoscope 2 is detachably connected to the light source apparatus 3 via the connector 9, and also detachably connected to the processing apparatus 4 via a connector 11 provided at an end portion of a cable 10 extending from a side of the connector 9.

On the distal end side of the insertion portion 6, a distal end portion 14 in which, e.g., an illumination optical system 12 and an objective optical system 13 are disposed is provided, and a bending portion 15, which is a bendable moving section, is continuous with a rear portion of the distal end portion 14. Furthermore, a flexible tube portion 16 having a long length and flexibility, which includes a flexible tubular member, is provided so as to be continuous with a rear portion of the bending portion 15. It should be noted that a bending operation of the bending portion 15 is performed via, e.g., a bending operation knob disposed at the operation section 7.

Also, a light guide fiber 17 that conveys illuminating light from the light source apparatus 3 is inserted in the insertion portion 6, and an exit end of the light guide fiber 17 is arranged so as to face a rear side of the illumination optical system 12 in the distal end portion 14. Illuminating light exiting from the illumination optical system 12 is reflected by an object such as a diseased part and enters from the objective optical system 13 in the distal end portion 14. Behind the objective optical system 13, an image pickup section 18 including a solid image pickup device 18a such as a CCD or a CMOS disposed at an image formation position of the objective optical system 13 and a circuit substrate portion 18b including a circuit chip mounted thereon, the circuit chip performing processing of drive and input/output signals for the solid image pickup device 18a, and light from an object which is formed into an image by the objective optical system 13 is subjected to photoelectric conversion in the solid image pickup device 18a.

A signal cable 20 extends from the circuit substrate 18b of the image pickup section 18. The signal cable 20 is inserted in the insertion portion 6, and connected from the operation section 7 to the processing apparatus 4, which is a subsequent stage signal processing section, via the universal cord 8, the connector 9, the cable 10 and the connector 11. The processing apparatus 4 includes, e.g., an image pickup device drive circuit, a processing circuit, an A/D converter, an image memory and an image processing circuit (including various types of correction circuits), and sends drive signals to the solid image pickup device 18a via the signal cable 20, and receives image pickup signals from the solid image pickup device 18a, the image pickup signals being amplified in the circuit substrate portion 18b and performs various types of signal processing to generate image signals. The image signals generated in the processing apparatus 4 are sent to the monitor 5, and an observation image of the object picked up by the solid image pickup device 18a is displayed on the monitor 5.

An outer diameter of the signal cable 20 that transmits signals between the solid image pickup device 18a and the subsequent stage processing apparatus 4 is not large even though the signal cable 20 has a cable structure like that of a single-layer structure, enabling reduction in diameter as with a cable having a double-layer structure. In addition, in the signal cable 20, a load is imposed not only on center-side electric wires as opposed to cables with a double-layer structure, but is evenly distributed, enabling prevention of the possibility of wire disconnection.

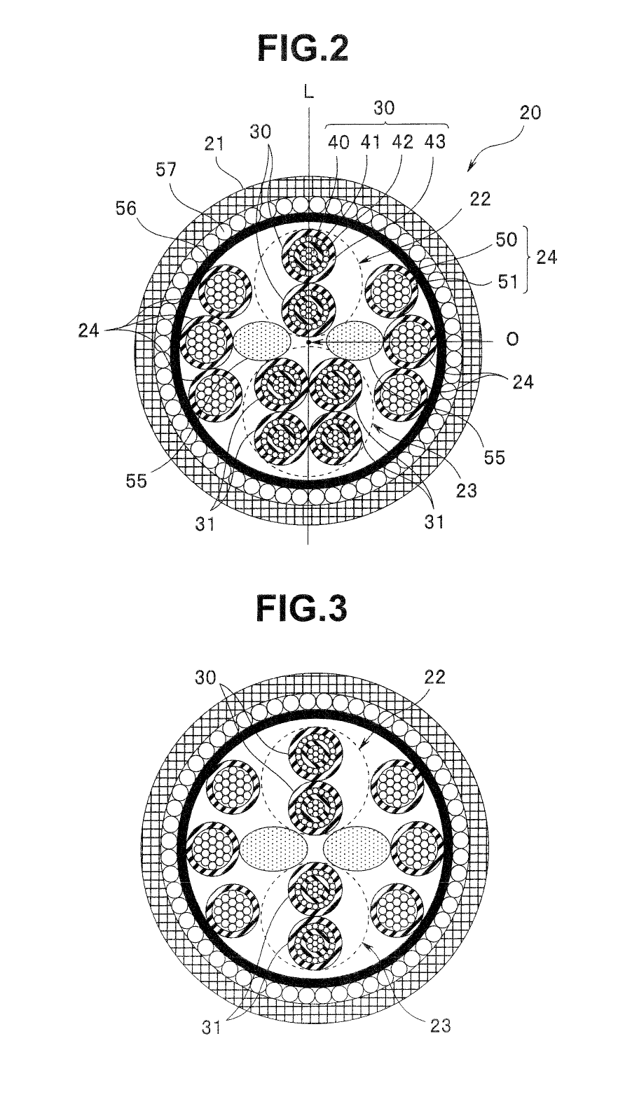

Hereinafter, an inner structure of the signal cable 20 will be described. FIG. 2 illustrates an example of the signal cable 20. In the signal cable 20, a plurality of composite cables 22, . . . are arranged on a substantially straight line so as to pass through a center axis of the entire signal cable 20 (cable center axis), and electric wires 24, . . . other than the composite cables 22, . . . are arranged at positions that are substantially symmetrical to each other with respect to the straight line on which the composite cables are arranged, in a sheath 21, which is an outer covering.

Here, the composite cables 22, . . . are each formed by unitizing a plurality of electric wires of a same system by twisting and bundling. Unitizing a plurality of electric wires means that the plurality of electric wires can physically be handled like a single electric wire. Also, the plurality of unitized composite cables are arranged not only on one straight line passing through the cable center axis. For example, where four composite cables are provided, two composite cables are symmetrically arranged on each of two straight lines passing through the cable center axis.

In the example in FIG. 2, more specifically, two composite cables 22, 23 are arranged so as to be substantially positioned on a straight line L passing through a cable center axis O, and six electric wires 24, . . . other than the composite cables 22, 23 are arranged at positions that are substantially symmetrical to each other with respect to the straight line L passing through the cable center axis O. One composite cable 22 is formed by unitizing two coaxial wires 30, 30, which transmit drive signals for solid image pickup device 18a, by twisting and bundling. The other composite cable 23 is formed by unitizing four coaxial wires 31, . . . , which transmit output signals from the solid image pickup device 18a, by twisting and bundling.

In FIG. 2, the coaxial wires 30, 31 in the respective composite cables 22, 23 each have a general structure in which a conductor core wire 40 is covered by an insulator 41 and a periphery of the insulator 41 is covered by a shield 42 formed by twisting a plurality of conductor wires together and is lastly covered by a sheath 43 of an insulator. In FIG. 2, the conductor core wire 40 includes a plurality of conductive wires, but may be a coaxial wire in which a conductor core wire includes a single wire. Also, although the composite cables 22, 23 each have an outer diameter of a unitized cable indicated by a dashed line in FIG. 2, e.g., a tape may be wound on an outer circumference of such unitized cable.

Meanwhile, the other six electric wires 24, . . . are electric wires for power supply and grounding (for example, five electric wires that supply positive and negative power and one ground wire), and in FIG. 2, each of the electric wires is a simple wire formed by covering a core wire 50 including a plurality of conductor wires by an insulating outer covering 51. These six electric wires (simple wires) 24, . . . are arranged with three simple wires facing the other three simple wires across the composite cables 22, 23, and between the simple wires 24 and the composite cables 22, 23, inclusions 55 each including, e.g., a staple fiber yarn or a Kevlar fiber yarn are packed.

The composite cables 22, 23 and the simple wires 24, . . . are collectively twisted and bundled, and an insulating binding tape 56 including, e.g., PTFE (polytetrafluoroethylene) is wound in a spiral shape on an outer circumference thereof. Furthermore, an outer circumference of the binding tape 56 is shielded by an overall shield 57 formed by twisting a plurality of conductor wires that include, for example, a silver-plated copper alloy, together, and lastly, the overall shield 57 is covered by a sheath 21 that includes, e.g., PFA (fluorocarbon polymer), whereby the signal cable 20 is formed.

As described above, in the signal cable 20 according to the present embodiment, a plurality of electric wires are unitized as the composite cables 22, . . . by twisting and bundling, and thus, each of the unitized composite cables 22, . . . can mechanically be regarded as one electric wire, enabling the unitized composite cables 22, . . . and the other electric wires 24, . . . to be arranged like a single-layer structure. Accordingly, in the signal cable 20, a load is not imposed only on the center-side electric wires as opposed to signal cables with a conventional double-layer structure and is evenly distributed, preventing disconnection of the electric wires.

Also, the signal cable 20 can have a symmetrical layout in which composite cables or other electric wires are arranged at positions facing each other, and thus, the layout is a balanced and stable layout, enabling enhancement in mechanical tolerance. For example, in the case of a non-symmetric layout in which only one other electric wire is interposed between composite cables, a load is imposed on the electric wire and the electric wire may fall in a gap between electric wires, resulting in disconnection of the electric wire; however, the signal cable 20 is free from such possibility and because of the symmetrical layout, it is easy to form the entire cable into a round shape, enabling manufacturing stability enhancement and product quality stabilization.

In such case, from the viewpoint of diameter reduction, a composite cable can be regarded as one thick electric wire, and thus, may have a somewhat irregular single-layer structure rather than a complete single-layer structure. However, insertion of inclusions 55 into gaps generated between the composite cables and the other electric wires enables efficient reduction in diameter of the cable, providing the advantage of enhanced diameter reduction compared to normal single-layer structures.

Also, in this case, a twist pitch p1 of each of the composite cables 22, 23, a twist pitch p2 of the overall shield 57 and a twist pitch p3 of the entire cable (twist pitch of the composite cables 22, 23 and the simple wire 24 collectively twisted together) are made to be different from one another so as to have a relationship of p1<p2<p3, for example, p1=7 mm, p2=10 mm and p3=13 to 15 mm. Consequently, the twists of the unitized composite cables can be prevented from being released, and the overall shield 57 can be prevented from falling between gaps between twists of the entire cable, enabling enhancement in mechanical tolerance of the overall shield 57 and stabilization in layout and enhancement in mechanical tolerance of the entire cable.

Furthermore, use of electric wires of a same system for a unitized composite cable enables reduction in effect of crosstalk on signals transmitted in the respective systems. For example, where a drive signal wire and an output signal wire, which are of different systems, are mixed and unitized, the drive signal wire and the output signal wire are close to each other in physical distance, causing an effect of crosstalk between signals; however, in the signal cable 20 according to the present embodiment, electric wires of a same system are unitized, and thus, composite cables of different systems such as a drive signal system and an output signal system can be arranged at a predetermined physical distance from each other, enabling suppression of crosstalk.

In the aforementioned example in FIG. 2, in the signal cable 20, two coaxial wires 30, 30, which transmit drive signals, are unitized by twisting and bundling, and four coaxial wires 31, . . . , which transmit output signals, are unitized by twisting and bundling. Accordingly, in terms of electric wire gauge, electric wires of each system have a same gauge, for example, drive signal wires have a gauge of, for example, AWG44, output signal wires have a gauge of, for example, AWG42, and the other power supply signal wires have a gauge of, for example, AWG36.

Thus, in the signal cable 20, distances between the respective output signal wires and the drive signal wires can be made to be equal to one another in a fixed cycle, preventing an effect of crosstalk from being imposed only on a certain output signal. Also, gauges of electric wires of the respective systems are decreased in the order of the power supply signal system, the output signal system and the drive signal system, and thus, unitization of electric wires of a same gauge makes an outer diameter of the unitized composite cable have a stable round shape, providing the advantages of the layout of the entire cable being stabilized and the mechanical tolerance being enhanced.

Also, inclusions 55 are packed into gaps generated between composite cables and between composite cables and simple wires, enabling provision of a physical distance between the drive signal wires and the output signal wires, and thus, the effect of high-frequency radiant noise generated from drive signals being mixed into output signals can be reduced. For the physical distance and the level of the radiant noise mixture, the radiant noise mixture level is inversely proportional to the square of the distance, and thus, it is effective to increase the physical distance to the maximum possible extent.

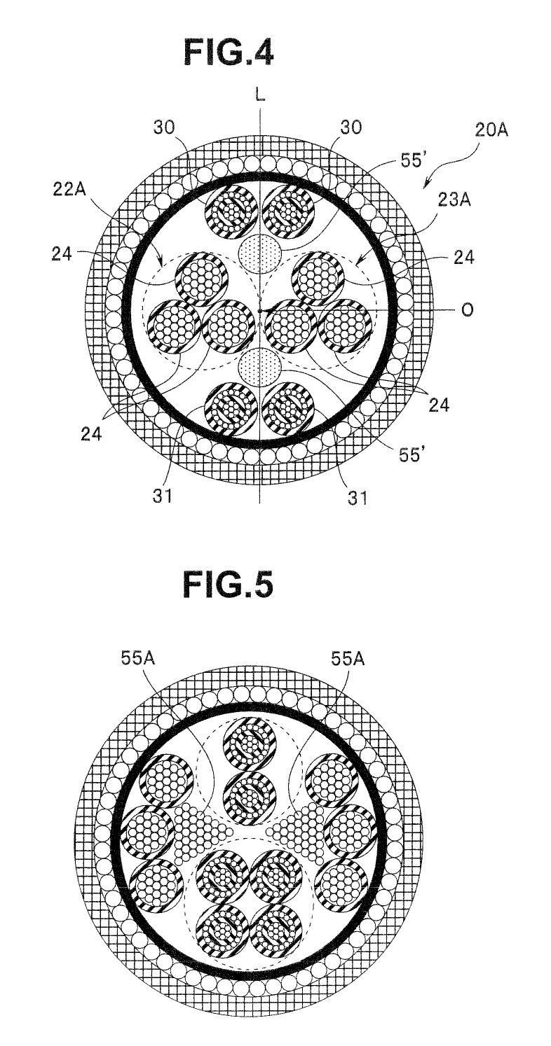

In this case, the unitized composite cables are not limited to those in the example of FIG. 2, and as illustrated in FIG. 3, a composite cable 23 of an output signal system may be one formed by unitizing two coaxial wires 31, 31 by twisting and bundling although a unitized composite cable 22 of a drive signal system is the same as that in the example of FIG. 2. Also, for composite cables, coaxial wires of a drive system or an output system are not unitized, but as illustrated in FIG. 4, simple wires of a power supply system may be unitized by twisting and bundling.

A signal cable 20A, which is illustrated in FIG. 4, includes two coaxial wires 30, 30 of a drive signal system, two coaxial wires 31, 31 of an output signal system and six simple wires 24, . . . of a power supply system (including a ground), and three simple wires (which are, for example, all power supply wires) unitized as a composite cable 22A by twisting and bundling, and three simple wires (which are, for example, two power supply wires and one ground wire) unitized as a composite cable 23A by twisting and bundling.

The composite cables 22A, 23A are arranged at positions that are substantially symmetrical to each other across a straight line L passing through a cable center axis O vertically in the Figure. The two coaxial wires 30, 30 of the drive signal system and the coaxial wires 31, 31 of the output signal system are not unitized, and the coaxial wires 30, 30 are arranged at positions that are symmetrical to each other across the straight line L. The coaxial wires 31, 31 are also arranged at positions that are symmetrical to each other across the straight line L. Furthermore, the set of the coaxial wires 30, 30 and the set of coaxial wires 31, 31 are arranged at positions that are substantially symmetrical to each other with respect to a center axis on which the composite cables 22A, 23A are arranged in a substantially straight line, that is, an axial line (not illustrated) crossing the straight line L at right angles at the cable center axis O. In such signal cable 20A, the composite cables 22A, 23A including unitized simple wires are arranged between the drive signal wires and the output signal wires, and thus, a physical distance between the drive signal wires and the output signal wires is provided, enabling reduction in effect of crosstalk between drive signals and output signals.

In this case, inclusions 55′ may be arranged in gaps generated between the composite cables 22A, 23A and the other coaxial wires 30, 31, but the composite cables 22A, 23A serve as walls between the drive signal wires (coaxial wires 30, 30) and the output signal wires (coaxial wires 31, 31). Thus, in the signal cable 20A in FIG. 4, a sufficient physical distance between the drive signal wires and the output signal wires can be provided without packing of inclusions 55′, enabling reduction in effect of crosstalk between drive signals and output signals.

Next, various variations of the signal cable 20 for suppression of crosstalk and more reliable blocking of radiation of drive signals to the outside will be described. Here, although variations based on the signal cable 20 will be described, the variations can be applied also to the above-described signal cable 20A and any other signal cable equivalent to the signal cable 20.

FIG. 5 is a variation in which the inclusions 55 of the signal cable 20, which each includes a staple fiber yarn or a Kevlar fiber yarn, are replaced with inclusions 55A that each includes a conductor wire, and the inclusions 55A of the conductor have a potential that is the same as that of a ground. Thus, a conductor having a potential that is the same as that of the ground is provided between drive signal wires and output signal wires, and thus, high-frequency radiation from drive signals can reliably be reduced to a ground level, enabling further reduction in effect of crosstalk.

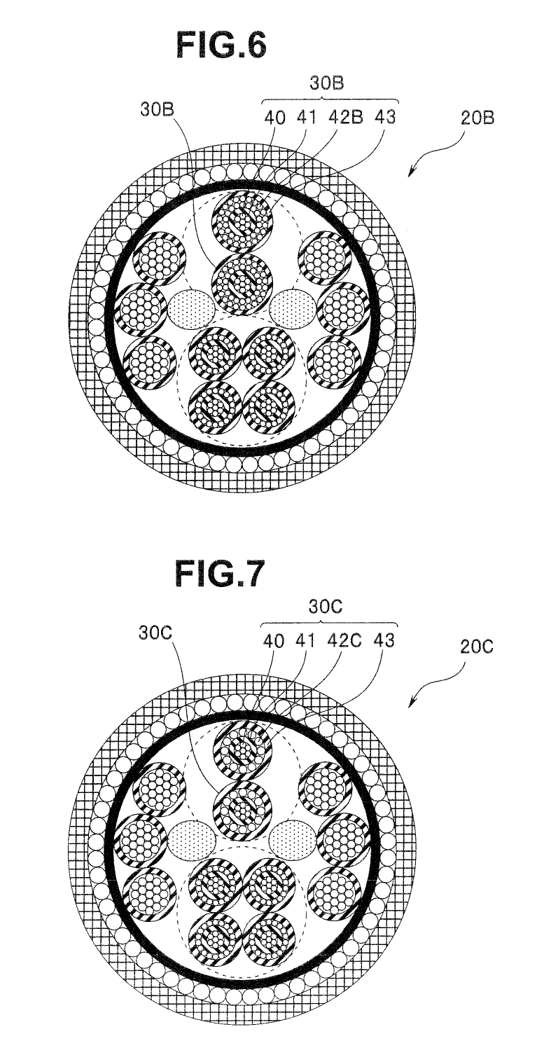

Also, FIGS. 6 and 7 are examples in which a shield of each coaxial wire of a drive signal system is reinforced. In a signal cable 20B, which is illustrated in FIG. 6, the two coaxial wires 30, 30 included in the composite cable 22 of the drive signal system in the signal cable 20 are changed to coaxial wires 30B, 30B in which an insulator 41 on a conductor core wire 40 is covered by a dual shield 42B. The signal cable 20B with the reinforced shield of the coaxial wires enables enhancement in effect of shielding against high-frequency waves, and thus, enables more reliable blocking of radiation from drive signals to the outside.

Meanwhile, a signal cable 20C, which is illustrated in FIG. 7, the two coaxial wires 30, 30 included in the composite cable 22 of the drive signal system in the signal cable 20 are changed to coaxial wires 30C, 30C in which an insulator 41 on a conductor core wire 40 is covered by a shield 42C having an increased gauge. The signal cable 20C also enables enhancement in effect of shielding against high-frequency waves and thus, enables more reliable blocking of radiation from drive signals to the outside.

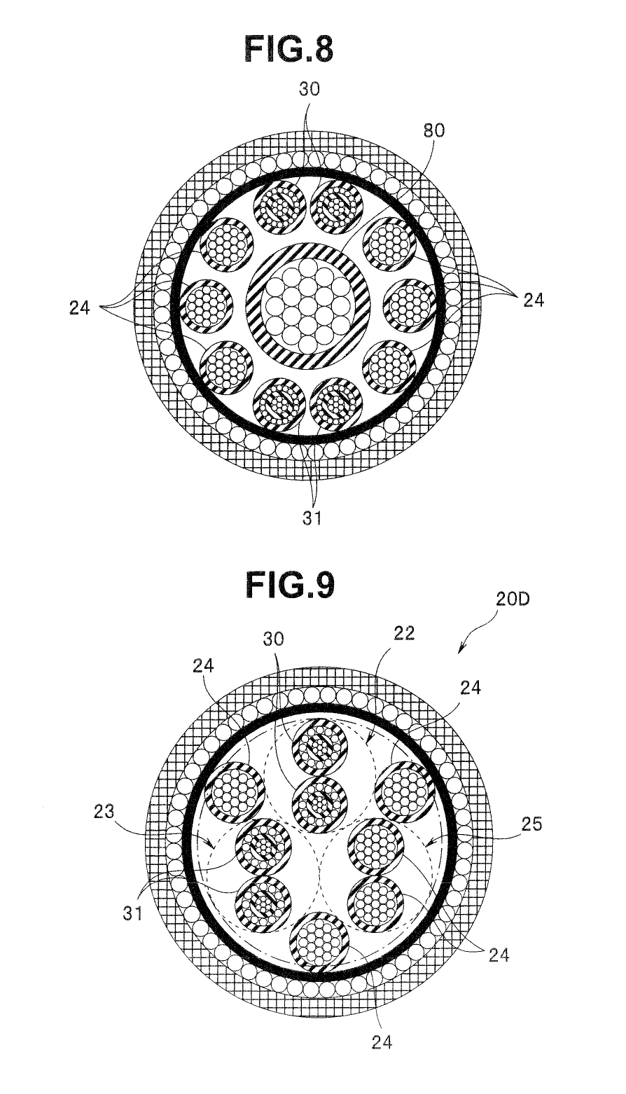

Also, in order to reduce an effect of crosstalk between drive signals and output signals, a cable structure with an improvement of a signal cable with a conventional single-layer structure including an inclusion packed in a center portion thereof may be employed. In other words, although in a signal cable with a conventional single-layer structure, an inclusion is packed in a center portion thereof, as illustrated in FIG. 8, a cable structure in which a ground wire 80 having an increased gauge to enhance the ground effect is arranged at a center instead of the inclusion in the center portion may be employed.

In the cable structure in FIG. 8, around the ground wire 80 in the center portion, coaxial wires 30, 30 of a drive signal system and coaxial wires 31, 31 of an output signal system are arranged so as to face each other, and between the coaxial wires 30, 30 of the drive signal system and the coaxial wires 31, 31 of the output signal system, six simple wires 24, . . . of a power supply signal system, which includes a ground, are symmetrically arranged, enabling reduction in effect of crosstalk between drive signals and output signals. In this case, since the cable structure is a double-layer structure, a mechanical strength of the ground wire 80 in the center is decreased, but the possibility of disconnection of the ground wire 80 can be reduced by increasing the gauge of the ground wire 80, and even if the ground wire 80 is disconnected, there is no risk of an image being lost because the ground wire 80 is a ground wire.

Next, a second embodiment of the present invention will be described.

In the above-described signal cable according to the first embodiment, a plurality of unitized composite cables are arranged on a straight line passing through a cable center axis, and a plurality of non-unitized electric wires are arranged at positions that are symmetrical to each other with respective to the straight line. Meanwhile, in a signal cable according to the second embodiment, as illustrated in FIGS. 9 to 11, a plurality of electric wires are arranged at positions adjacent to composite cables, which includes a case where a plurality of composite cables are not arranged on a straight line passing through a cable center axis.

Hereinafter, a description will be provided focusing mainly on differences from the first embodiment. A signal cable 20D, which is illustrated in FIG. 9, includes three composite cables, i.e., a composite cable 22 formed by unitizing two coaxial wires 30, 30 of a drive signal system by twisting and bundling, a composite cable 23 formed by unitizing two coaxial wires 31, 31 of an output signal system by twisting and bundling, a composite cable 25 formed by unitizing two simple wires from among five simple wires 24, . . . of a power supply system (including a ground).

The three composite cables 22, 25, 23 are arranged adjacent to one another surrounding a cable center axis clockwise in FIG. 9, and the remaining three non-unitized simple wires 24, 24, 24 are arranged at positions adjacent to respective composite cables 22, 25, 23 in such a manner that the simple wires 24, 24, 24 are laid on a circumference of a circle circumscribing the three composite cables 22, 25, 23, which is indicated by the alternate long and short dash line in the Figure. More specifically, the three non-unitized simple wires 24, 24, 24 are arranged in such a manner that a center of each of the non-unitized simple wires 24, 24, 24 is laid on a circumference of a circle having a diameter smaller than that of the circle circumscribing the composite cables 22, 23, 25 and being substantially concentric with that circle.

In the signal cable 20D with such configuration, also, an effect of crosstalk on output signals by drive signals is evenly imposed on the respective output signal wires because the two output signal wires are unitized, and thus, the effect of crosstalk is prevented from being imposed only on a certain output signal.

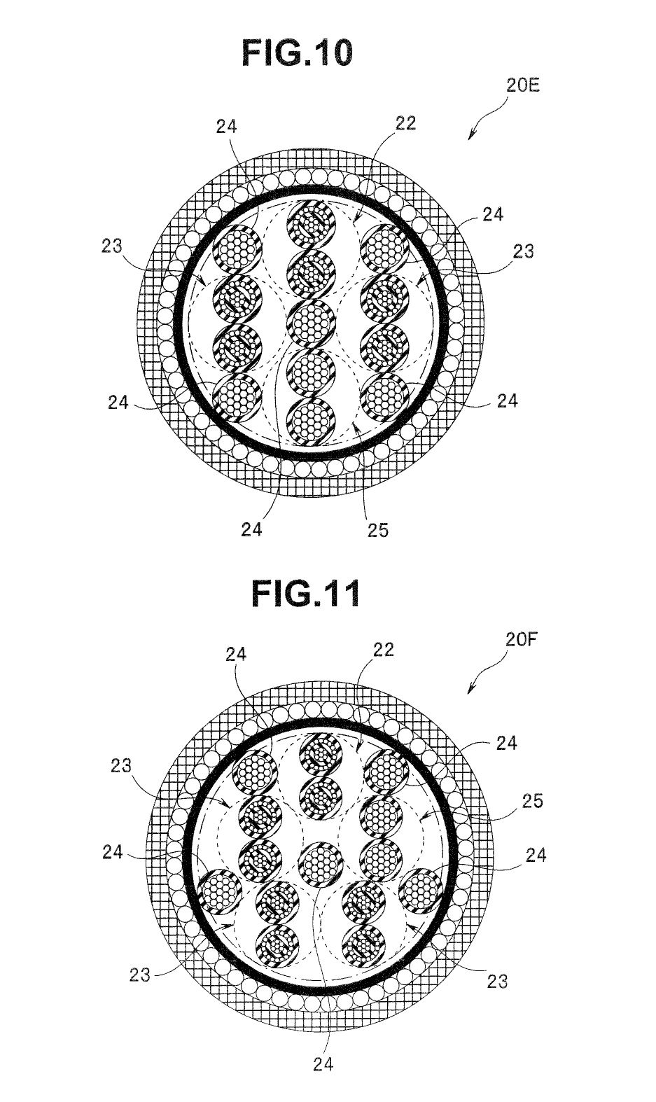

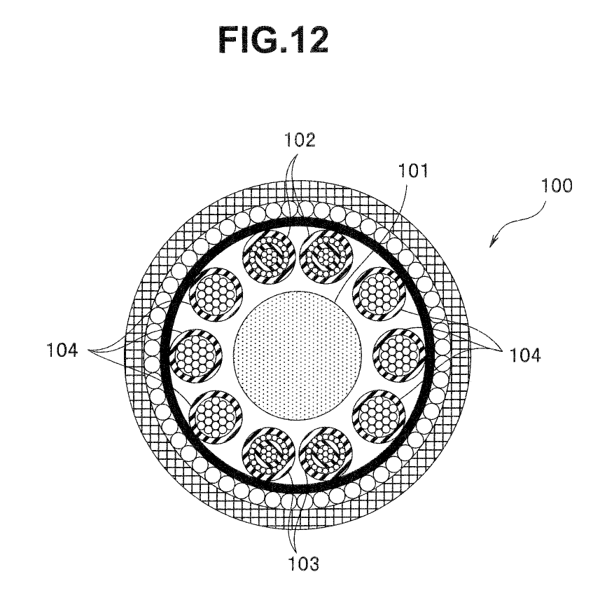

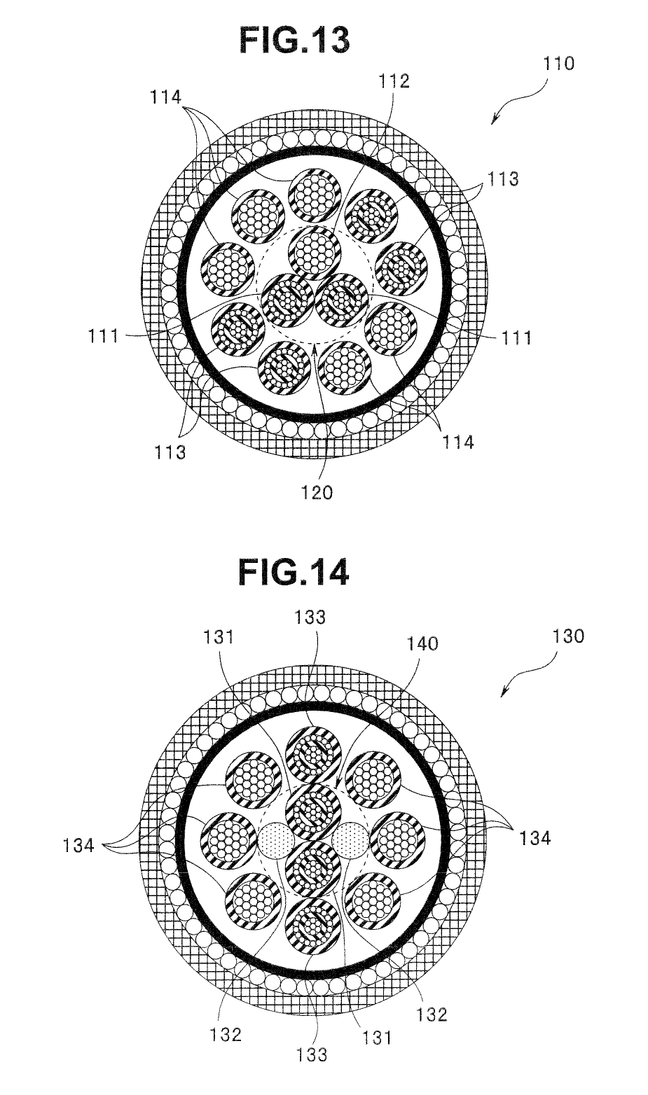

Also, FIGS. 10 and 11 each illustrate a configuration substantially similar to that in FIG. 9: FIG. 10 illustrates a case where four unitized composite cables are provided; and FIG. 11 illustrates a case where five composite cables are provided. A signal cable 20E in FIG. 10 includes a total of four composite cables, i.e., a composite cable 22 of a drive signal system, two composite cables 23, 23 of an output signal system, a composite cable 25 formed by unitizing two simple wires from among seven simple wires 24, . . . of a power supply system (including a ground), and the four composite cables 22, 23, 25, 23 are arranged so as to surround a cable center axis clockwise in FIG. 10. In other words, the two composite cables 23, 23 of the output signal system are arranged on a horizontal straight line passing through the cable center axis in FIG. 10, and the composite cable 22 of the drive system and the composite cable 25 of the power supply system are arranged on a vertical straight line crossing the straight line at right angles at the cable center axis, and thus, the composite cables 23, 23 and the composite cable 22, 25 are arranged in a cross, surrounding the cable center axis.

Also, a signal cable 20F, which is illustrated in FIG. 11, includes a total of five composite cables, i.e., a composite cable 22 of a drive signal system, three composite cables 23, 23, 23 of an output signal system, a composite cable 25 formed by unitizing two simple wires from among seven simple wires 24, . . . of a power supply system (including a ground). The five composite cables 22, 25, 23, 23, 23 are arranged in such a manner that the composite cables 22, 25, 23, 23, 23 surround a cable center axis clockwise in FIG. 11 and a center of the composite cables has a substantially pentagonal shape.

In the signal cables 20E, 20F in FIGS. 10 and 11, also, the four non-unitized simple wires 24, . . . are arranged adjacent to the respective composite cables at positions where the non-unitized simple wires 24, . . . are laid on a circumference of a circle circumscribing the respective composite cables (circle indicated by the alternate long and short dash line in FIGS. 10 and 11). In this case, there is an empty space inside the circumference of the circle circumscribing the respective composite cables (a center of the entire signal cables), and thus, one electric wire can be put in the empty space. Where an electric wire is arranged in the empty space, it is desirable that the electric wire is a ground wire because the mechanical tolerance of the electric wire becomes relatively low; however, an inclusion may be charged instead of the electric wire. In FIGS. 10 and 11, the ground wire from among the seven simple wires 24, . . . of the power supply system is arranged in the space at the center of the cable.

The types of the above-described electric wires in FIGS. 9 to 11 are not limited to the illustrated patterns, and for example, unitized composite cables may each include coaxial wires alone, or a coaxial wire and a simple wire may be unitized.

What is claimed is:

1. A signal cable for an endoscope, the signal cable electrically connecting an image pickup section and a subsequent stage signal processing section of the endoscope,
wherein a plurality of composite cables each formed by unitizing a plurality of electric wires by twisting and bundling are provided;
wherein in a cross-section perpendicular to a direction in which the signal cable extends, the plurality of composite cables are arranged in parallel along a straight line passing through a center axis of the entire signal cable and a plurality of non-unitized electric wires are arranged at positions that are substantially symmetrical to each other with respect to the center axis; and
wherein the plurality of unitized composite cables and the plurality of non-unitized electric wires are collectively twisted and bundled, thereby forming the signal cable.

2. The signal cable for an endoscope according to claim 1, wherein at least one of the composite cables is formed by unitizing electric wires of a same signal system by twisting and bundling.

3. The signal cable for an endoscope according to claim 2, wherein at least one of the composite cables is arranged in such a manner that composite cables of different signal systems are arranged at a physical distance from each other.

4. The signal cable for an endoscope according to claim 1, wherein at least one of the composite cables is formed by unitizing cables for a drive signal that drives a solid image pickup device in the image pickup section, by twisting and bundling.

5. The signal cable for an endoscope according to claim 1, wherein at least one of the composite cables is formed by unitizing cables for an output signal from a solid image pickup device in the image pickup section, by twisting and bundling.

6. The signal cable for an endoscope according to claim 1, wherein at least one of the composite cables is formed by unitizing coaxial wires by twisting and bundling.

7. The signal cable for an endoscope according to claim 1, wherein at least one of the composite cables is formed by unitizing simple wires by twisting and bundling.

8. The signal cable for an endoscope according to claim 1, wherein a twist pitch of each of the composite cables is smaller than a twist pitch of the entire signal cable.

9. A signal cable for an endoscope, the signal cable electrically connecting an image pickup section and a subsequent stage signal processing section of the endoscope,
wherein a plurality of composite cables each formed by unitizing a plurality of electric wires by twisting and bundling are provided;
wherein a plurality of non-unitized electric wires are arranged at positions adjacent to the unitized composite cables; and
wherein the plurality of unitized composite cables and the plurality of non-unitized electric wires are collectively twisted and bundled, thereby forming the signal cable.

10. The signal cable for an endoscope according to claim 9, wherein the plurality of non-unitized electric wires are arranged on or inside a circumference of a circle circumscribing the plurality of unitized composite cables.
